(19) United States
(12) Patent Application Publication
(10) Pub. No.: US 2016/0129378 A1
(43) Pub. Date: May 12, 2016

(54) POOL FILTER WITH INTEGRATED PUMP

(71) Applicant: Hayward Industries, Inc., Elizabeth, NJ (US)

(72) Inventors: Benoit Joseph Renaud, Clemmons, NC (US); Edward Lawrence Marciano, Lexington, NC (US); Robert Rung, Hopatcong, NJ (US)

(73) Assignee: HAYWARD INDUSTRIES, INC., Elizabeth, NJ (US)

(21) Appl. No.: 14/932,363

(22) Filed: Nov. 4, 2015

Related U.S. Application Data
(60) Provisional application No. 62/076,895, filed on Nov. 7, 2014.

(51) Int. Cl. B01D 35/26

(52) U.S. Cl. CPC B01D 35/26

(57) ABSTRACT

A pool filter with integrated pump is disclosed herein. The pool filter with integrated pump, comprising a filter housing having an inlet, an outlet, and defining one or more chambers in fluid communication with the inlet and the outlet thereby at least partially defining a fluid flow path therebetween, a filter media housed within the filter housing and positioned such that the fluid flow path progresses through the filter media, and a pump assembly (at least partially) housed within the filter housing, the pump assembly including a pump motor and an impeller in mechanical communication with the pump motor, the pump assembly positioned such that the fluid flow path progresses through the impeller.

### CROSS-REFERENCE TO RELATED APPLICATIONS

The present application claims the benefit of priority to U.S. Provisional Patent Application No. 62/076,895, filed Nov. 7, 2014, the contents of which are incorporated herein by reference in their entirety for all purposes.

### BACKGROUND OF THE INVENTION

1. Field of the Invention

The present invention relates to pool filters and, more specifically, to pool filters and pumps.

2. Background

Many pool systems require a filter system and pump system, which are usually separate units interconnected with one another by piping. Assembly of these units may include mounting each of a pump and a filter on a flat base, and then measuring, cutting, and gluing a pipe to fit between them. This can be difficult for many users, especially for those not accustomed to pool maintenance and installation. Further, having two separate devices may require a large foot print (e.g., pool pad), which may be burdensome for smaller spaces and pools.

Thus, a need exists for a system that combines the pumping system and filtering system into one device that is compact and easy to install. These and other needs are addressed by the pool filter with integrated pump of the present disclosure.

### SUMMARY

The present disclosure is directed to a pool filter with an integrated pump. The device integrates a filter system and pump system into one compact unit. Disclosed herein is a pool filter with integrated pump, comprising a filter housing having an inlet, an outlet, and defining one or more chambers in fluid communication with the inlet and the outlet thereby at least partly defining a fluid flow path therebetween, wherein the one or more chambers include a filter chamber sized and shaped to house a filter media, wherein the one or more chambers include a pump cavity sized and shaped to house at least a portion of a pump assembly. The pool filter could further comprise a filter media housed within the filter chamber of the filter housing and positioned such that the fluid flow path progresses from an exterior to an interior of the filter media. The pool filter could further comprise a pump assembly at least partially housed within the pump cavity of the filter housing, the pump assembly including a pump motor and an impeller in mechanical communication with the pump motor, the pump assembly positioned such that the fluid flow path progresses through the impeller. The inlet could be in fluid communication with a water body. The filter housing could include a pump casing wall that defines the pump cavity. An inner surface of the pump casing wall and an outer surface of the pump assembly could define a casing chamber for fluid flow therethrough. The filter media could be vertically aligned within the filter housing (or oriented in any other manner). The pool filter could further comprise a filter basket for coarse material housed within a top portion of (or attached at any other location within) the filter housing. The impeller could be provided as a plurality of impellers, and the fluid flow path could progress through one or more of the plurality of impellers. Further, a combination pool filter assembly could include a pre-filter and the pool filter with integrated pump. The pre-filter could be outside the pool filter housing of the pool filter with integrated pump and in fluid communication therewith. The fluid flow path progresses through the pre-filter before proceeding into the filter housing of the pool filter with integrated pump.

Also disclosed herein is a pool filter with integrated pump, comprising a filter housing having an inlet, an outlet, and defining one or more chambers in fluid communication with the inlet and the outlet thereby at least partially defining a fluid flow path therebetween, a filter media housed within the filter housing and positioned such that the fluid flow path progresses from an exterior to an interior of the filter media, and a pump assembly housed within the filter housing, the pump assembly including a pump motor and an impeller in mechanical communication with the pump motor, the pump assembly positioned such that the fluid flow path progresses through the impeller. The inlet could be in fluid communication with a water body. The filter housing could include a pump casing wall that defines a pump cavity, and the pump assembly could be housed within the pump cavity. An inner surface of the pump casing wall and an outer surface of the pump assembly could define a casing chamber for fluid flow therethrough. The filter media could be vertically aligned within the filter housing (or oriented in any other manner). The pool filter could further comprise a filter basket for coarse material housed within a top portion of (or attached at any other location within) the filter housing. The impeller could be provided as a plurality of impellers, and the fluid flow path could progress through one or more of the plurality of impellers. Further, a combination pool filter assembly could include a pre-filter and the pool filter with integrated pump. The pre-filter could be outside the pool filter housing of the pool filter with integrated pump and in fluid communication therewith. The fluid flow path progresses through the pre-filter before proceeding into the filter housing of the pool filter with integrated pump.

### BRIEF DESCRIPTION OF THE DRAWINGS

The foregoing features of the invention will be apparent from the following Detailed Description, taken in connection with the accompanying drawings, in which:

FIG. 1 is a schematic section view of a filter and pump assembly in accordance with a first example embodiment;

FIG. 2 is a diagrammatic cross-sectional schematic view of the filter and pump assembly of FIG. 1 taken along section line 2-2 thereof;

FIG. 3 is a diagrammatic cross-sectional view of the filter and pump assembly of FIG. 1 taken along section line 3-3 thereof;

FIG. 4 is a diagrammatic top plan view of a filter and pump assembly in accordance with a second example embodiment;

FIG. 5 is a diagrammatic cross-sectional schematic view of the filter and pump assembly of FIG. 4 taken along section line 5-5 thereof;

FIG. 6 is a perspective partial cross-sectional view of the filter and pump assembly of FIG. 4;

FIG. 7 is a perspective view of a bottom manifold of the filter and pump assembly of FIG. 4; and

FIG. 8 is a perspective view of a top manifold of the filter and pump assembly of FIG. 4.

### DETAILED DESCRIPTION

Disclosed herein is a pool filter with an integrated pump. Although a pool filter is disclosed a described, the pool filter could be used with any type of water body and is not limited to just pools. Some advantages of the pool filter with an integrated pump include that the operation of the pump is quieter (when the pump is housed within the pool filter) and the motor and drive are cooled by the pool water (when the pump is positioned in the fluid flow path). Further, the pool filter with an integrated pump could reduce costs and reduce the complexity of the multi-port valve. Additionally, the pool filter with an integrated pump could reduce time to purge air in the filter, and could be easy to prime (when filled with water). Further, the pool filter with an integrated pump could be used with any type of filter (e.g., sand filter, cartridge filter, top mount valve filters, side mount valve filters, etc.). The integrated pump and/or internal filter piping could be designed to maximize hydraulic efficiency and sized appropriately for the application desired (e.g., gallons per minute (GPM), pressure, etc.), and could be used with a flow rated system and be self-priming.

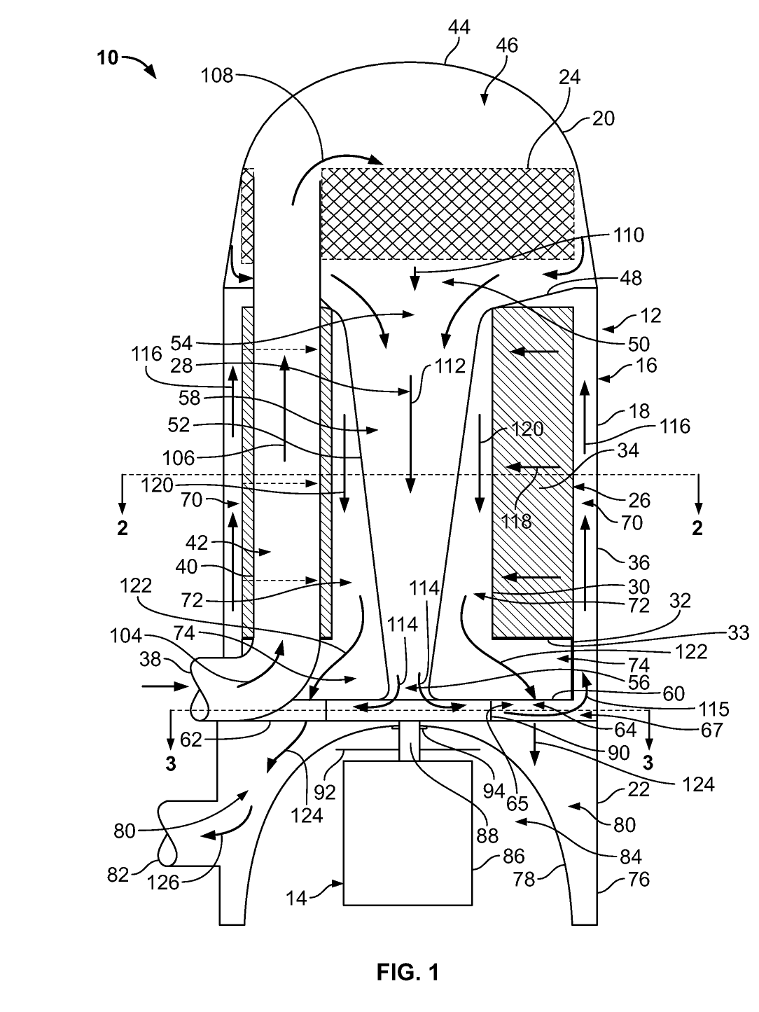

FIGS. 1-3 are schematic views of a pool filter with an integrated pump (e.g., filter and pump assembly 10). More specifically, FIG. 1 is a schematic section view of a filter and pump assembly 10 in accordance with a first example embodiment. The filter and pump assembly 10 comprises a filter assembly 12 (e.g., filter system) and a pump assembly 14 (e.g., pump system), described in more detail below. The pump assembly 14 could be built into or attached to the side of the filter assembly 12 (e.g., at the top or bottom of the filter assembly 12).

The filter assembly 12 comprises a filter housing 16, a filter basket 24, a filter media 26 (e.g., filter cartridge), with a fluid flow path 28 flowing through the filter housing 16, as described in more detail below. Of course, other examples of filter media 26 could include any filter media such as sand filter media, a diatomaceous earth filter media, etc. The filter housing 16 comprises a filter housing middle portion 18, a filter housing top portion 20, and a filter housing lower portion 22. The filter basket 24 is designed to filter large or coarse materials (e.g., sticks, leaves, etc.). Alternatively, the filter basket 24 could be made of a fabric mesh and/or be conically shaped to fit within the first conical sidewall 48 and/or second conical sidewall 52 (e.g., for greatest economy and largest open area). The filter media 26 comprises an inner cylindrical wall 30 with pleats 34 extending outwardly therefrom. The pleats 34 could be long vertical pleats that extend from the top to the bottom of the filter media 26 (e.g., forming an annular envelope), where the pleats 34 are positioned annularly around the inner cylindrical wall 30 (thereby forming a generally cylindrical shape). The filter media 26, including inner cylindrical wall 30 and pleats 34 have less porosity than the filter basket 24 and are designed to filter smaller materials. The filter media 26 is shown and described as cylindrical, which is understood to comprise an annular envelope, for example, but could be of any shape. Any suitable filter basket 24 and filter media 26 could be used.

The filter housing middle portion 18 includes a middle portion outer sidewall 36, which could be cylindrically shaped. However, the middle portion sidewall 36 could be of a conical shape, which could reduce the outer diameter toward the top portion 20 where axial flow is less. Such a design could reduce cost and facilitate molding. An inlet 38 could be positioned in the middle portion outer sidewall 36. The inlet 38 is in fluid communication with a pool (or other water body), and water requiring filtration enters the filter and pump assembly 10 through the inlet 38. The inlet 38 is structurally connected to (e.g., integral with) a first tube 40 such that they are in fluid communication with one another. The first tube 40 defines a first, cylindrical chamber 42 and is vertically aligned within (but offset from the center of) the filter housing middle portion 18.

Top portion 20 includes a top portion hemispherical top wall 44 which defines a second, hemispherical chamber 46. However, the top portion hemispherical top wall 44 could be of any of a variety of shapes (e.g., Cassinian dome, ellipsoidal, etc.). The filter basket 24 is positioned within the second, hemispherical chamber 46 (the first conical sidewall 48, and/or the second conical sidewall 52). The first tube 40 could extend into the second, hemispherical chamber 46, such that the outlet of the first tube 40 is adjacent to the top of the filter basket 24. In the top portion 20, but beneath the filter basket 24 is a first conical sidewall 48 defining a third, conical chamber 50. The second, hemispherical chamber 46 and filter basket 24 are cooperatively shaped so that any fluid from the second, hemispherical chamber 46 must pass through the filter basket 24 before entering the third, conical chamber 50.

The middle portion 18 further comprises a second conical sidewall 52, the second conical sidewall 52 being vertically aligned and defining a conical sidewall inlet 54, a conical sidewall outlet 56, and a fourth, conical chamber 58 therebetween. The conical sidewall inlet 54 is larger than the conical sidewall outlet 56, and the conical sidewall inlet 54 is adjacent to and in fluid communication with the third, conical chamber 50. In this way, fluid from the third, conical chamber 50 continues to the fourth, conical chamber 58.

The middle portion 18 further includes a disc upper wall 60 and a disc lower wall 62 positioned beneath the disc upper wall 60, the disc lower wall 62 being opposite and parallel to the disc upper wall 60. Between the disc upper wall 60 and disc lower wall 62 are a plurality of sets of angularly displaced enclosed vertical walls 66 (discussed in more detail below with FIG. 3), where each set of angularly displaced enclosed vertical walls 66 define an angularly displaced (essentially) triangular opening 68. The angularly displaced enclosed vertical walls 66 and the angularly displaced triangular openings 68 are discussed in more detail below. The disc upper wall 60, disc lower wall 62, and outer surface of the angularly displaced enclosed vertical walls 66 define a fifth, disc chamber 64, being of a generally disc-like shape. The fifth, disc chamber 64 comprises a diffuser section 65 and a void section 67. The diffuser section 65 is proximate impeller 90, and the void section 67 is proximate the inside surface of the middle portion outer sidewall 36. The periphery of the disc upper wall 60 includes an upwardly extending middle portion inner sidewall 32, which could include an inwardly protruding ledge 33, where the filter media 26 could rest on the middle portion inner sidewall 32 and/or the ledge 33. The conical sidewall outlet 56 is in fluid communication with the fifth, disc chamber 64 (e.g., and not in fluid communication with triangular openings 68), discussed in more detail below.

The middle portion 18 further comprises a sixth, annular chamber 70 defined by the outer surface of the pleats 34 of the filter media 26 and the inside surface of the middle portion outer sidewall 36 (as well as the outer surface of the middle portion inner sidewall 32 and the inside surface of the middle portion outer sidewall 36). As a result, the sixth, annular chamber 70 is vertically aligned. The bottom of the sixth, annular chamber 70 is in fluid communication with the outer perimeter of the fifth, disc chamber 64.

The middle portion 18 also comprises a seventh, inner chamber 72 defined by the inner surface of the pleats 34 (and/or the inner cylindrical wall 30) of the filter media 26 and the outer surface of the second conical sidewall 52. As a result, the seventh, inner chamber 72 is vertically aligned and is shaped to have a cylindrical outer perimeter with a conical inner perimeter. Thereby, the seventh, inner chamber 72 is tapered to form a closed top and an open bottom. In this way, any fluid from the sixth, annular chamber 70 must pass through the pleats 34 of the filter media 26 before continuing to the seventh, inner chamber 72.

The middle portion 18 further includes an eighth, upper disc annular chamber 74 defined by the middle portion inner sidewall 32, the disc upper wall 60, and the bottom of the filter media 26 (and/or the bottom of ledge 33). The eighth, upper disc annular chamber 74 is in fluid communication with the open bottom (e.g., outlet) of the seventh, inner chamber 72, as well as the angularly displaced triangular openings 68.

The filter housing lower portion 22 includes a lower portion sidewall 76 (which could be of a consistent size and diameter as the middle portion outer sidewall 36) and a lower portion hemispherical wall 78. A ninth, lower disc chamber 80 is defined by the disc lower wall 62, the lower portion hemispherical wall 78, and the lower portion sidewall 76. An outlet 82 is positioned in the lower portion sidewall 76 and is in fluid communication with the ninth, lower disc chamber 80. The outlet 82 is in fluid communication with a pool (or other water body), and water, having been filtered through the filter media 26, exits the filter and pump assembly 10 through the outlet 82.

The lower portion hemispherical wall 78 defines a pump assembly cavity 84, which houses the pump assembly 14. As used herein, the pump assembly cavity 84 refers to negative space defined by the filter housing lower portion 22 in which at least a portion of the pump assembly 14 resides, where pump assembly 14 refers to the pump and/or components thereof (e.g., pump wet end, pump electrical end, etc.). The pump assembly 14 includes a pump motor 86, pump motor shaft 88, impeller 90, and slinger disc 92. The pump motor 86 is mechanically connected to the pump motor shaft 88, which is mechanically connected to the impeller 90. The pump motor 86 is housed within the pump assembly cavity 84, and the pump motor shaft 88 extends from the pump assembly cavity 84 into the fifth, disc chamber 64. The pump motor 86 does not require a housing (as it is confined within pump assembly cavity 84), which enhances heat dissipation to the outer surface of the filter housing 16. A lower seal 94 could be provided around the pump motor shaft 88 to seal the pump assembly cavity 84 from fluid. The power from the pump motor 86 could alternatively be transferred through the use of a magnetic coupler, eliminating shaft seals. The impeller 90 is positioned within the fifth, disc chamber 64 and is discussed in more detail below.

Alternatively, the pumping assembly 14 could be attached at the top of the filtering assembly 12, such that if a seal breaks, gravity will prevent water from intruding into the pump motor 86. Moreover, the pump motor 86 could be a submersible motor (e.g., by providing a shroud for the motor). In this way, by putting the pump motor 86 inside the fluid, the fluid could be used to cool the pump motor 86 and reduce noise from the pump motor 86 (e.g., due to insulation of the fluid).

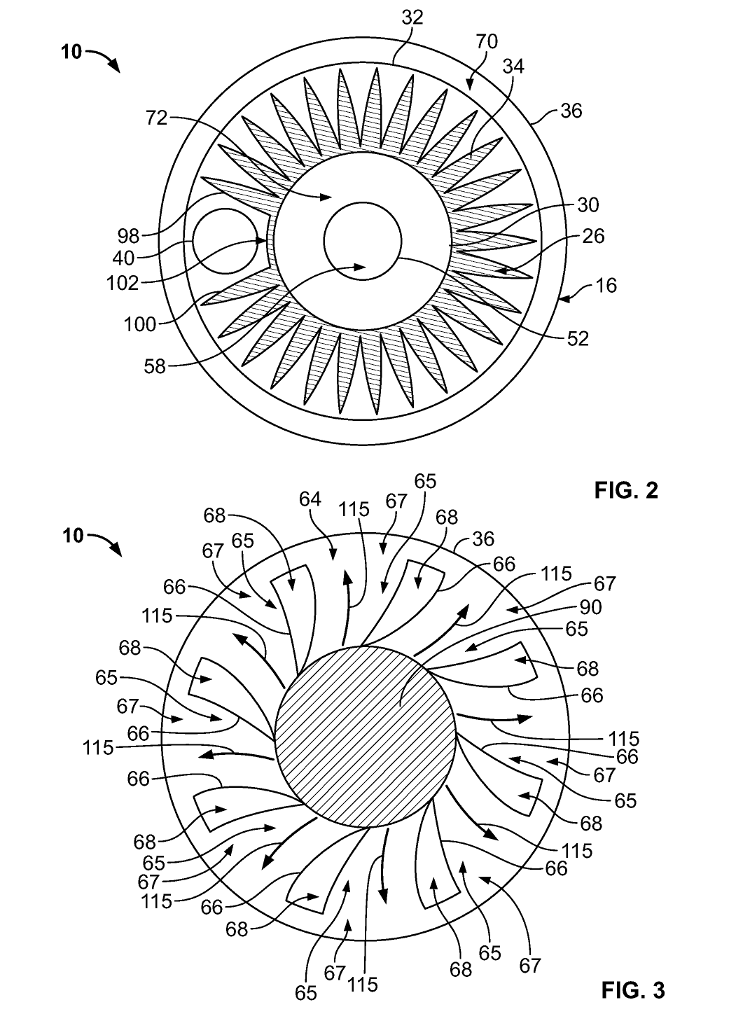

FIG. 2 is a diagrammatic cross-sectional view of the pool and filter assembly 10 of FIG. 1 taken along section line 2-2 thereof. The center of the pump and filter assembly 10 along line 2-2 comprises the fourth, conical chamber 58, which is surrounded by and defined by the second conical sidewall 52. Surrounding the second conical sidewall 52 is the seventh, inner chamber 72 defined by the outer surface of the second conical sidewall 52 and the inner surface of the inner cylindrical wall 30 of the filter media 26. As explained above, on the outer surface of the inner cylindrical wall 30 are pleats 34. The pleats 34 begin at a first pleat end 98 and continue annularly until ending at a second pleat end 100. The first pleat end 98 and the second pleat end 100 define a pleat slot 102. The pleat slot 102 is sized to accommodate the first tube 40 therein. The first tube 40 could be positioned further away from the center of the filter housing 16, so that the pleat slot 102 would not be needed. Surrounding the filter media 26 is the sixth, annular chamber 70 defined by the outer surface of the pleats 34 and the inner surface of the middle portion outer sidewall 36. Alternatively, the inlet 38 could be routed outside the assembly to enter at the crown of the second, upper hemi-spherical chamber 46, such as through a gooseneck fitting. This would allow a larger filter media 26, easier servicing of the filter basket 24, and a clear view of the filter basket 24 if the gooseneck fitting is transparent.

FIG. 3 is a diagrammatic cross-sectional view of the pump and filter assembly 10 of FIG. 1 taken along section line 3-3 thereof. The center of the pump and filter assembly 10 along line 3-3 comprises the impeller 90 of the pump assembly 14. FIGS. 1 and 3 are schematic diagrams which include the impeller 90, generally depicted, where a person of ordinary skill in the art understands the structure of the impeller 90. At the periphery of the impeller 90 are a plurality of sets of angularly displaced enclosed vertical walls 66, with each set defining a angularly displaced triangular opening 68. As shown, the diffuser section 65 of the fifth, disc chamber 64 is between each section of vertical walls 66 and proximate to the impeller 90. The void section 67 of the fifth, disc chamber 64 is radially outwardly from the diffuser section 65 and proximate the inner surface of the middle portion outer sidewall 36. The plurality of angularly displaced triangular openings 68 permits the fluid communication of the eighth, upper disc annular chamber 74 with the ninth, lower disc chamber 80. Outside of the plurality of sets of angularly displaced enclosed vertical walls 66 is the middle portion outer sidewall 36. As shown, the impeller 90 draws water from the fourth, conical chamber 58 and disperses the water through the fifth, disc chamber 64 (e.g., through the diffuser section 65 and void section 67) in the spaces (e.g., channels) between the plurality of sets of angularly displaced enclosed vertical walls 66. The impeller could be provided as a plurality of impellers, and the fluid flow path could progress through one or more of the plurality of impellers.

Fluid through the pump and filter assembly 10 of FIGS. 1-3 follows flow path 28, which, in the example described herein, includes a first flow path 104, a second flow path 106, a third flow path 108, a fourth flow path 110, a fifth flow path 112, a sixth flow path 114, a seventh flow path 115, an eighth flow path 116, an ninth flow path 118, a tenth flow path 120, an eleventh flow path 122, a twelfth flow path 124, and a thirteenth flow path 126. First, fluid enters the pump and filter assembly 10 by a first flow path 104 through the inlet 38. Fluid then continues by a second flow path 106 through the first, cylindrical chamber 42 of the first tube 40 towards the top portion 20 of the filter housing 16. Fluid then continues by a third flow path 108 into the second, upper hemi-spherical chamber 46 defined by the top portion hemispherical top wall 44. The fluid is then filtered through the filter basket 24 and continues by a fourth flow path 110 into the third, conical chamber 50 defined by the first conical sidewall 48. The fluid then continues by a fifth flow path 112 through the fourth, conical chamber 58 defined by the second conical sidewall 52. The fluid is drawn into the impeller 90 (e.g., the impeller could be provided as one or more impellers, and the fluid being drawn into one or more of the impellers) of the pump assembly 14 along a sixth flow path 114 and then dispersed along a seventh flow path 115 into the fifth, disc chamber 64 (through the diffuser section 65 and then the void section 67), where it continues by an eighth flow path 116 into the sixth, annular chamber 70. The fluid then proceeds by a ninth flow path 118 through the pleats 34 of the filter media 26 where the fluid is further filtered. The fluid proceeds by a tenth flow path 120 through a seventh, inner chamber 72 to an eleventh flow path 122 through an eighth, upper disc annular chamber 74. The fluid then continues through the angularly displaced triangular openings 68 defined by the angularly displaced enclosed vertical walls 66 and then proceeds by a twelfth flow path 124 to the ninth, lower disc chamber 80, where it exits by a thirteenth flow path 126 through the outlet 82.

In some embodiments, to backwash the filter and pool assembly 10 a second disc area could be added above the disc upper wall 60 for the filter and pump assembly 10 with a second diffuser positioned between the disc and the disc upper wall 60. An external means could be used to raise the impeller 90 (e.g., a lift rod accessible from a top), such that when the impeller 90 is raised, it discharges flow through the second diffuser into eight, upper disc annular chamber 74, thereby reversing the flow through the filter media 26. In this way, fluid would flow from the raised impeller 90 through the second diffuser, in the reverse of ninth flow path 118, in the reverse of eighth flow path 116, in the reverse of seventh flow path 115, and then exiting below the elevated impeller 90 into ninth, lower disc chamber 80, where it exits by thirteenth flow path 126 through outlet 82.

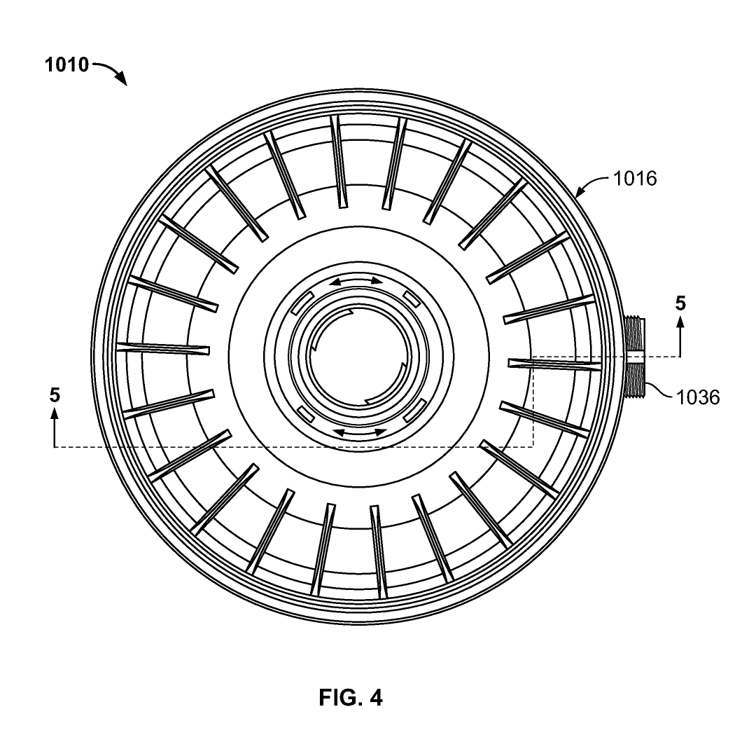

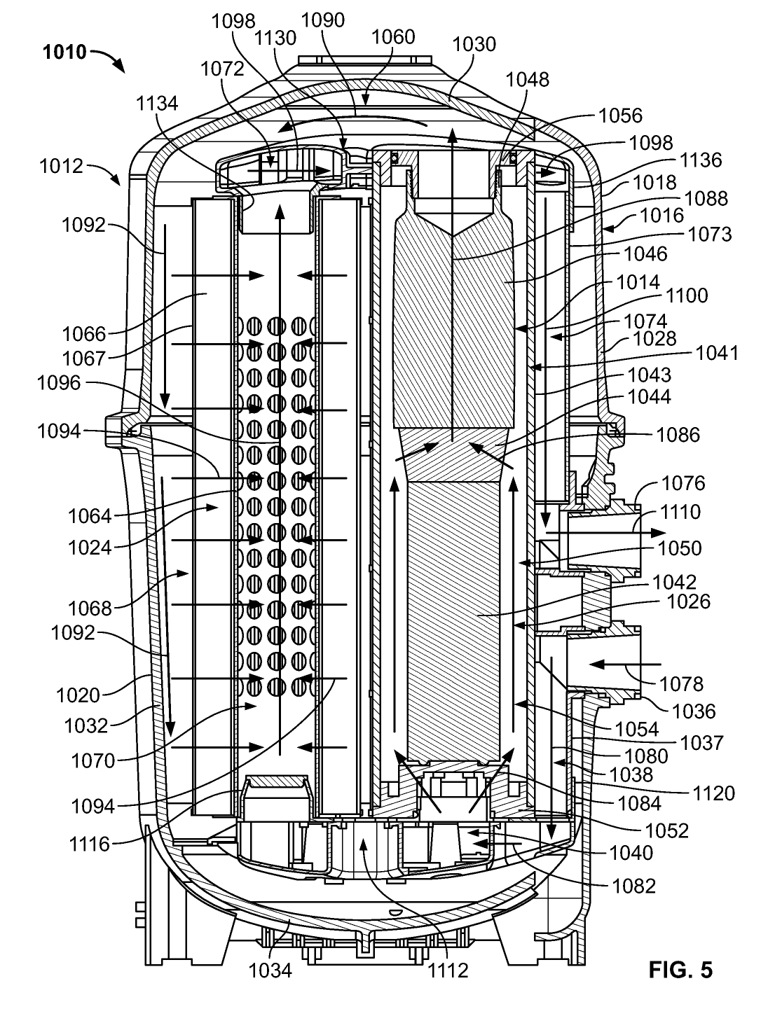

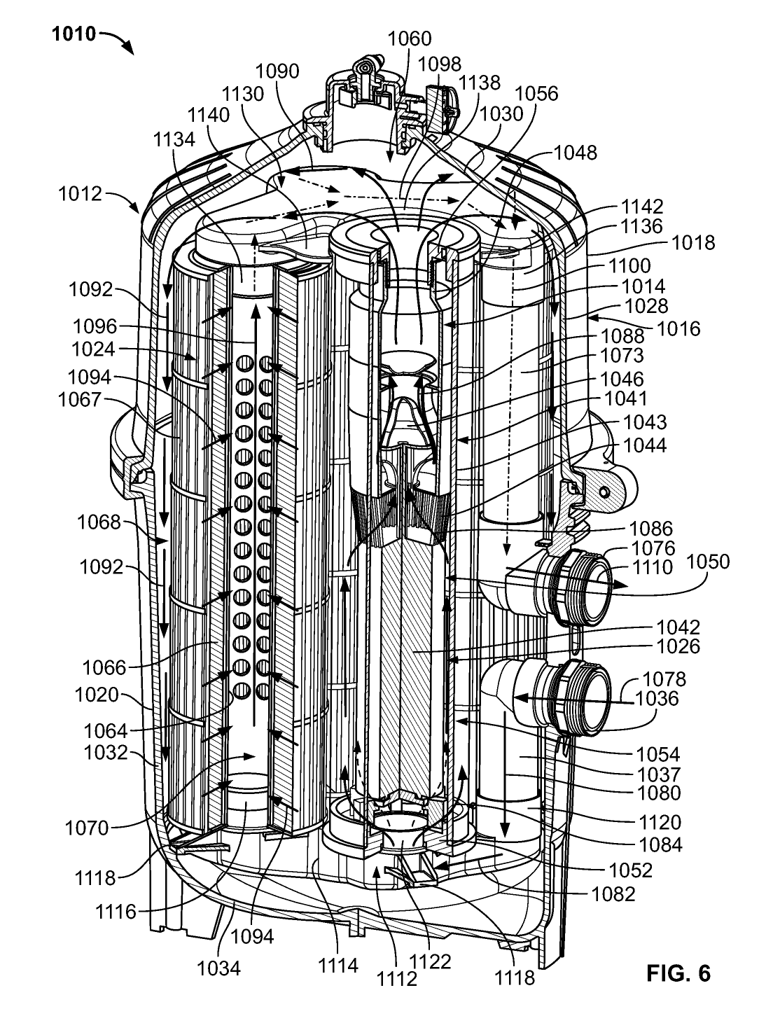

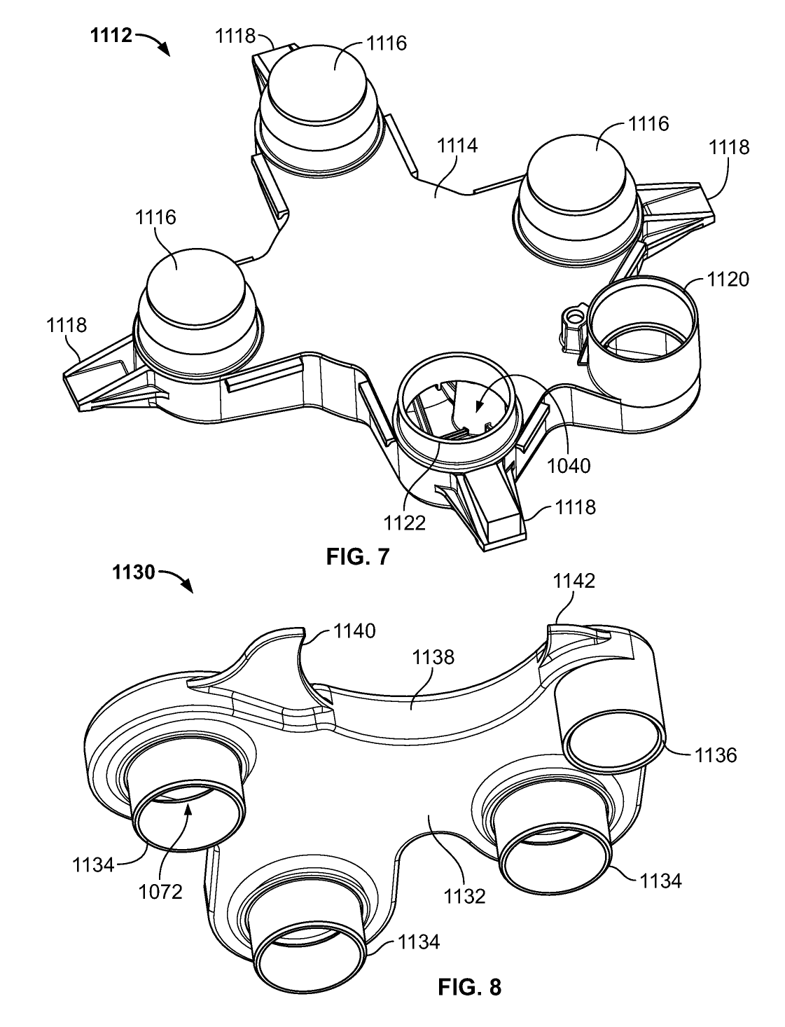

FIGS. 4-8 are views of a pool filter with an integrated pump (e.g., filter and pump assembly 1010). More specifically, FIG. 4 is a top plan view of a filter and pump assembly 1010 in accordance with a second example embodiment. FIG. 5 is a diagrammatic cross-sectional schematic view of the pool and filter assembly 1010 of FIG. 4 taken along section line 5-5 thereof. FIG. 6 is a perspective partial cross-sectional view of the filter and pump assembly 1010 of FIG. 4. FIG. 7 is a perspective view of a bottom manifold of the filter and pump assembly 1010 of FIG. 4. FIG. 8 is a perspective view of a top manifold of the filter and pump assembly 1010 of FIG. 4.

The filter and pump assembly 1010 comprises a filter assembly 1012 and a pump assembly 1014. The filter assembly 1012 comprises a filter housing 1016 having a top portion 1018 and a bottom portion 1020. Housed within the filter housing 1016 are the pump assembly 1014 and one or more filter media 1024, with a fluid flow path 1026 flowing through the filter housing 1016, as described in more detail below.

The top portion 1018 comprises a top cylindrical sidewall 1028 and a top wall 1030. Similarly, the bottom portion 1020 comprises a bottom cylindrical sidewall 1032 and a bottom wall 1034. The top portion 1018 and bottom portion 1020 are removably attached (e.g., by clamps, threaded rings, bolts, etc.) to one another to form an enclosure to house one or more filter media 1024 and pump assembly 1014.

An inlet 1036 is positioned in the bottom cylindrical sidewall 1032. The inlet 1036 is in fluid communication with a pool (or other water body), and water requiring filtration enters the filter and pump assembly 1010 through the inlet 1036. A first inlet tube 1037 defines a first, inlet chamber 1038. The first inlet tube 1037 is vertically aligned and is connected to the inlet 1036 at one end, and connected to an inlet 1120 of a bottom manifold 1112 at the other end.

Bottom manifold 1112 (see FIG. 7) includes a bottom manifold body 1114 defining a second, bottom chamber 1040 and having one or more posts 1116 extending from a top surface of the body 1114, where each post 1116 is sized and shaped to engage an inner cylindrical wall 1064 of a filter media 1024. Further, each post 1116 could include a plug to prevent any fluid flow into, or out of, the post 1116. The number of posts 1116 could vary with the number of filter media 1024 to be used in the filter and pump assembly 1010. The bottom manifold 1112 further comprises an inlet 1120 and outlet 1122, each having a sleeve extending from the top surface of the bottom manifold body 1114 and each providing access to the interior of the bottom manifold 1112 (e.g., the second, bottom chamber 1040). The inlet 1120 and outlet 1122 are thereby in fluid communication with one another. The bottom manifold 1112 can further comprise one or more standoffs 1118 outwardly extending from a periphery of the bottom manifold body 1114. The standoffs 1118 could be used for mounting the bottom manifold 1112 to an interior of the filter housing 1016.

The pump assembly 1014 (e.g., deep well pump or other pump with a sealed motor) comprises a pump casing 1041, a pump motor 1042, a screen 1044 (or strainer) in mechanical communication with the pump motor 1042, an impeller 1046, and a pump outlet 1048. The screen 1044 is positioned between the pump motor 1042 and the impeller 1046, and the impeller 1046 is positioned between the screen 1044 and the pump outlet 1048. The screen 1044 ensures no large particles enter into the impeller 1046.

The pump casing 1041 includes a pump casing wall 1043 defining a pump assembly cavity 1050 (e.g., pump cavity), a lower mount 1052 (which could act as an inlet gasket) at an inlet end of the pump casing 1041, and an upper mount 1056 (which could act as an outlet gasket) at an outlet end of the pump casing 1041. The Pump casing wall 1043 is cylindrically shaped (but could be of any shape). The pump assembly 1014 is positioned within the pump assembly cavity 1050, such that the pump motor is in the bottom portion 1020 of the filter housing 1016, and the impeller 1046 is in the top portion 1018 of the filter housing 1016. The pump motor 1042 of the pump assembly 1014 is mounted to the lower mount 1052. The pump outlet 1048 is threadably engaged with the upper mount 1056, although any type of attachment could be used. The lower mount 1052 is engaged with the outlet 1122 of the bottom manifold 1112. A third, casing chamber 1054 is defined between the inner surface of the pump casing wall 1043 and the outer surface of the pump motor 1042 of the pump assembly 1014.

A top manifold 1130 is positioned in the top portion 1018 of the filter housing 1016, above the pump assembly 1014. A fourth, top chamber 1060 is defined between an outer surface of the top manifold 1130 and an inner surface of a top wall 1030.

One or more filter media 1024 are positioned within the filter housing 1016 adjacent to the pump casing 1041. The filter media 1024 is vertically aligned and extends from the bottom portion 1020 to the top portion 1018. The filter media 1024 includes an inner cylindrical wall 1064 and pleats 1066 having an outer surface 1067. A fifth, side outer filter chamber 1068 is defined by an outer surface 1067 of the pleats 1066 of the filter media 1024 and an inner surface of the filter housing 1016 (e.g., inner surface of the top portion 1018 and bottom portion 1020). Further an inner surface of the inner cylindrical wall 1064 of the filter media 1024 defines a sixth, inner filter chamber 1070.

The top manifold 1130 (see FIG. 8) includes a top manifold body 1132 defining a seventh, top manifold chamber 1072 and including one or more inlets 1134, each inlet 1134 having a sleeve extending from the bottom surface of the top manifold body 1132, and where each inlet 1134 is sized and shaped to engage an inner cylindrical wall 1064 of a filter media 1024. Each inlet 1134 is in fluid communication with the seventh, top manifold chamber 1072. In this way, the seventh, top manifold chamber 1072 is in fluid communication with the sixth, inner filter chamber 1070 of the filter media 1024. The top manifold 1130 also comprises an outlet 1136 extending from the bottom surface thereof. The outlet 1136 is in fluid communication with the seventh, top manifold chamber 1072 of the top manifold 1130, and thereby in fluid communication with the one or more inlets 1134.

At least a portion of the periphery of the top manifold body 1132 defines a recessed portion 1138, and could include a first protrusion 1140 extending from one end of the recessed portion 1138, and a second protrusion 1142 extending from a second end of the recessed portion 1138. The recessed portion 1138, first protrusion 1140, and second protrusion 1142 together defining a partial circle to engage an exterior of at least a portion of the pump casing 1041, to secure the pump casing 1041 to the top manifold 1130.

An outlet tube 1073 defines an eighth, outlet chamber 1074, and has one end engaged with the outlet 1136 of the top manifold 1130, such that the eighth, outlet chamber 1074 is in fluid communication with the seventh, top manifold chamber 1072. The other end of the outlet tube 1073 is in fluid communication with an outlet 1076, which is positioned in the bottom cylindrical sidewall 1032.

Fluid through the pump and filter assembly 1010 of FIGS. 4-6 follows flow path 1026, which in the example described herein, includes a first flow path 1078, a second flow path 1080, a third flow path 1082, a fourth flow path 1084, a fifth flow path 1086, a sixth flow path 1088, a seventh flow path 1090, an eighth flow path 1092, a ninth flow path 1094, a tenth flow path 1096, an eleventh flow path 1098, a twelfth flow path 1100, and a thirteenth flow path 1110. First fluid enters the pump and filter assembly 1010 by a first flow path 1078 through the inlet 1036. Fluid then continues by a second flow path 1080 through the first, inlet chamber 1038 towards the bottom wall 1034 of the filter housing 1016. Fluid then continues by a third flow path 1082 through the second, bottom chamber 1040 defined by the bottom manifold 1112. The fluid proceeds by a fourth flow path 1084 through the lower mount 1052 to the third, casing chamber 1054 defined by the outer surface of the pump motor 1042 and the inner surface of the pump casing wall 1043. Fluid is then drawn through screen 1044 by fifth flow path 1086 where it then continues by sixth flow path 1088 through the impeller 1046 (e.g., the impeller could be provided as one or more impellers, and the fluid being drawn into one or more of the impellers), pump outlet 1048, and upper mount 1056. Fluid then enters by seventh flow path 1090 the fourth, top chamber 1060, which is partially defined by top wall 1030. The fluid continues by eighth flow path 1092 to the fifth, side outer filter chamber 1068, where it then proceeds by ninth flow path 1094 through the pleats 1066 of the filter media 1024, where the fluid is filtered. The fluid then proceeds by a tenth flow path 1096 through the sixth, inner filter chamber 1070 of the one or more filter media 1024 towards the inner surface of top manifold 1130 of the filter housing 1016. The fluid proceeds by eleventh flow path 1098 through the seventh, top manifold chamber 1072. The fluid then continues by twelfth flow path 1100 through the eighth, outlet chamber 1074, where it proceeds by a thirteenth flow path 1110 through the outlet 1076.

In some embodiments, backwashing the pool and filter assembly 1010 could depend on the type of pump motor 1042 and impeller 1046 used (e.g., purely axial flow impeller, submersible pump, etc.). Further, backwashing the pool and filter assembly 1010 could utilize a three-way valve (or other similar mechanism) internally incorporated with actuation by an external handle.

The pool filter with an integrated pump has been shown and described as a filter cartridge type of pool filter. However, any type of pool filter could be used. For example, the pool filter could be a sand filter or a diatomaceous earth pool filter (e.g., DE filter).

In some embodiments, a pool filter assembly could include a pre-filter and the pool filter with integrated pump described above. The pre-filter is in fluid communication with the pool filter with integrated pump and could be internal or external to the filter housing of the pool filter with integrated pump. The pre-filter could filter larger objects (e.g., leaves, sticks, etc.) prior to further filtering (e.g., of finer materials) by the pool filter. In this way, the fluid flow path progresses through the pre-filter before proceeding into the filter housing of the pool filter with integrated pump.

Having thus described the invention in detail, it is to be understood that the foregoing description is not intended to limit the spirit or scope thereof. It will be understood that the embodiments of the present invention described herein are merely exemplary and that a person skilled in the art may make many variations and modification without departing from the spirit and scope of the invention. All such variations and modifications, including those discussed above, are intended to be included within the scope of the invention.

1. A pool filter with integrated pump, comprising:
a filter housing having an inlet, an outlet, and defining one or more chambers in fluid communication with the inlet and the outlet thereby at least partly defining a fluid flow path therebetween,
wherein the one or more chambers include a filter chamber sized and shaped to house a filter media,
wherein the one or more chambers include a pump cavity sized and shaped to house at least a portion of a pump assembly.

2. The pool filter of claim 1, further comprising a filter media housed within the filter chamber of the filter housing and positioned such that the fluid flow path progresses through the filter media.

3. The pool filter of claim 1, further comprising a pump assembly at least partially housed within the pump cavity of the filter housing, the pump assembly including a pump motor and an impeller in mechanical communication with the pump motor, the pump assembly positioned such that the fluid flow path progresses through the impeller.

4. The pool filter of claim 1, wherein the inlet is in fluid communication with a water body.

5. The pool filter of claim 1, wherein the filter housing includes a pump casing wall that defines the pump cavity.

6. The pool filter of claim 5, wherein an inner surface of the pump casing wall and an outer surface of the pump assembly define a casing chamber for fluid flow therethrough.

7. The pool filter of claim 1, wherein the filter media is vertically aligned within the filter housing.

8. The pool filter of claim 1, further comprising a filter basket housed within a top portion of the filter housing.

9. A pool filter with integrated pump, comprising:
a filter housing having an inlet, an outlet, and defining one or more chambers in fluid communication with the inlet and the outlet thereby at least partially defining a fluid flow path therebetween;
a filter media housed within the filter housing and positioned such that the fluid flow path progresses through the filter media; and
a pump assembly housed within the filter housing, the pump assembly including a pump motor and an impeller in mechanical communication with the pump motor, the pump assembly positioned such that the fluid flow path progresses through the impeller.

10. The pool filter of claim 9, wherein the inlet is in fluid communication with a water body.

11. The pool filter of claim 9, wherein the filter housing further includes a pump casing wall that defines a pump cavity, and the pump assembly is housed within the pump cavity.

12. The pool filter of claim 11, wherein an inner surface of the pump casing wall and an outer surface of the pump assembly define a casing chamber for fluid flow therethrough.

13. The pool filter of claim 9, wherein the filter media is vertically aligned within the filter housing.

14. The pool filter of claim 9, further comprising a filter basket housed within a top portion of the filter housing.

15. The pool filter of claim 1, wherein the impeller is provided as a plurality of impellers, and the fluid flow path progresses through one or more of the plurality of impellers.

16. The pool filter of claim 9, wherein the impeller is provided as a plurality of impellers, and the fluid flow path progresses through one or more of the plurality of impellers.

17. A combination pool filter assembly, including a pre-filter and the pool filter with integrated pump of claim 1, the pre-filter in fluid communication with the pool filter with integrated pump.

18. The combination pool filter assembly of claim 16, wherein the pre-filter is outside the filter housing of the pool filter with integrated pump, and the fluid flow path progresses through the pre-filter before proceeding into the filter housing of the pool filter with integrated pump.

19. A combination pool filter assembly, including a pre-filter and the pool filter with integrated pump of claim 9, the pre-filter in fluid communication with the pool filter with integrated pump.

20. The combination pool filter assembly of claim 18, wherein the pre-filter is outside the filter housing of the pool filter with integrated pump, and the fluid flow path progresses through the pre-filter before proceeding into the filter housing of the pool filter with integrated pump.
